(19) United States
(12) Patent Application Publication
(10) Pub. No.: US 2025/0164638 A1
(43) Pub. Date: May 22, 2025

(54) METHOD AND SYSTEM FOR IDENTIFYING A STATIONARY TARGET WITH ULTRASOUND

(71) Applicant: INVENSENSE, INC, San Jose, CA (US)

(72) Inventor: Agnes Gomez, Grenoble (FR)

(21) Appl. No.: 18/614,016

(22) Filed: Mar. 22, 2024

Related U.S. Application Data
(60) Provisional application No. 63/601,627, filed on Nov. 21, 2023.

(51) Int. Cl. G01S 15/52; G01S 7/539

(52) U.S. Cl. CPC G01S 15/526; G01S 7/539

(57) ABSTRACT

Methods and systems are disclosed for employing an ultrasonic sensor to identify a stationary object. The ultrasonic transducer emits an ultrasonic pulse and receives returned signals corresponding to the emitted ultrasonic pulse. The returned signals are evaluated for candidate echoes of a first object. Characteristics of the received returned signals are compared to determine the first candidate echo represents a stationary object.

### CROSS-REFERENCE TO RELATED APPLICATIONS

This application claims priority to U.S. Provisional Patent Application No. 63/601,627, filed Nov. 21, 2023, the content of which is incorporated by reference in its entirety.

### FIELD OF THE PRESENT DISCLOSURE

This invention relates to the use of an ultrasonic transducer to classify objects as stationary and more particularly to distinguish such stationary objects from a user.

### BACKGROUND

A variety of devices exist which utilize sonic sensors (e.g., sonic emitters and receivers, or sonic transducers). By way of example, and not of limitation, a device may utilize one or more sonic sensors to track the location of the device in space, to detect the presence of objects in the environment of the device, and/or to avoid objects in the environment of the device. Such sonic sensors include transmitters which transmit sonic signals, receivers which receive sonic signals, and transducers which both transmit sonic signals and receive sonic signals. Many of these sonic transducers emit signals in the ultrasonic range, and thus may be referred to as ultrasonic transducers. Piezoelectric Micromachined Ultrasonic Transducers (PMUTs), which may be air-coupled, are one type of sonic transducer which operates in the ultrasonic range. Sonic transducers, including ultrasonic transducers, can be used for a large variety of sensing applications such as, but not limited to: virtual reality controller tracking, presence detection, object detection/location, and object avoidance. For example, drones, robots, security systems or other devices may use ultrasonic transducers and/or other sonic transducers in any of these or numerous other applications.

For example, devices such as computers, smartphones and others that are typically operated by a user in close proximity may benefit from presence detection to infer when a user is likely to be currently operating or otherwise interacting with the device. As will be discussed in further detail below, it is desirable for such presence detection techniques to be able to distinguish between the user and other objects that may be in similar proximity, such as the back of a chair. Conventionally, optical sensors have been employed to detect continuous presence such as by using a camera to track the face of the user, but these are relatively expensive and represent a significant use of power and processing resources. Similarly, a time-of-flight (ToF) sensor can sense a close target but cannot distinguish other objects from a user.

Using ultrasonic transducers for presence detection is an attractive alternative but still should be able to distinguish the user from other stationary objects. As one illustration, when a user is watching a video on a screen of the device, that person may remain substantially still with only the slight movement of breathing or subtle changes in position. Correspondingly, the successful implementation of presence detection using an ultrasonic transducer requires high sensitivity to small motion. However, ultrasonic sensors are known to be significantly affected by its environment, including airflow, temperature change and other factors, resulting in a relatively noisy signal. Indeed, even echoes coming back from static targets can be noisy. For instance, it has been found that chairs with a net back create sound interferences that lead to increased noise in the received echo.

Given the above characteristics, it would be desirable to provide systems and methods for determining whether received ultrasonic signals correspond to a stationary object, particularly so they can be distinguished from a user of the device. As will be described in the following materials, the techniques of this disclosure satisfy this and other needs.

### SUMMARY

The disclosure is directed to a device having an ultrasonic transducer configured to emit an ultrasonic pulse and receive returned signals corresponding to the emitted ultrasonic pulse. The device also has at least one processor coupled with the ultrasonic transducer and configured to evaluate the returned signals to identify a first candidate echo indicating a first object within range of the ultrasonic transducer, identify at least one subsequent candidate echo resulting from a subsequent emitted ultrasonic pulse and a subsequent received returned signal that corresponds to the first object, compare characteristics of the received returned signal and the subsequent received returned signal and determine the first candidate echo represents a stationary object.

This disclosure also includes a sensor processing unit, including an ultrasonic transducer configured to emit an ultrasonic pulse and receive returned signals corresponding to the emitted ultrasonic pulse and at least one sensor processor coupled with the ultrasonic transducer and configured to evaluate the returned signals to identify a first candidate echo indicating a first object within range of the ultrasonic transducer, identify at least one subsequent candidate echo resulting from a subsequent emitted ultrasonic pulse and a subsequent received returned signal that corresponds to the first object, compare characteristics of the received returned signal and the subsequent received returned signal and determine the first candidate echo represents a stationary object.

Further, this disclosure is also directed to a method for employing an ultrasonic sensor to identify a stationary object. The method may involve evaluating, employing at least one processor coupled with an ultrasonic transducer, returned signals from a pulse emitted by the ultrasonic transducer, identifying at least one subsequent candidate echo resulting from a subsequent emitted ultrasonic pulse and a subsequent received returned signal that corresponds to the first object, comparing characteristics of the received returned signal and the subsequent received returned signal and determining the first candidate echo represents a stationary object.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A and 1B show example block diagrams of some aspects of a device which includes a sonic transducer, in accordance with various embodiments.

FIG. 2 shows an example external depiction of a device using an ultrasonic transducer to identify a stationary object and distinguish the object from a user, in accordance with various embodiments.

FIG. 3 illustrates a flow diagram of a method of identifying a stationary object with an ultrasonic transducer, in accordance with various embodiments.

FIG. 4 illustrates a graph of raw magnitudes of returned signals received over a period of time by an ultrasonic transducer in a sensed environment such as a room, in accordance with various embodiments.

FIG. 5 illustrates the output of a user presence detection algorithm of the prior art.

FIG. 6 illustrates a graph of amplitude over range for candidate echoes corresponding to multiple objects, in accordance with various embodiments.

FIG. 7 illustrates a graph of range over time for the multiple objects of FIG. 6, in accordance with various embodiments.

FIG. 8 illustrates the output of a user presence detection algorithm following the determination of stationary objects and exclusion of the corresponding samples, in accordance with various embodiments.

FIG. 9 illustrates the output of a user presence detection algorithm when a user is present, in accordance with various embodiments.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more sensor processing units (SPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a Motion Processor Unit (MPU) or Sensor Processing Unit (SPU) and a microprocessor, a plurality of microprocessors, one or more microprocessors in conjunction with an MPU/SPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

Sonic transducers, which include ultrasonic transducers, emit a pulse (e.g., an ultrasonic sound) and then receive returned signals (i.e., echoes) after the ultrasonic waves from the emitted sound are reflected of objects or persons. In this manner, the returned signals correspond to the emitted pulse. In such a transducer, the returned signals can be used to detect the presence and/or location of objects from which the emitted pulse reflects and then returns to the transducer as a returned signal. In other instances, a first ultrasonic transducer may emit a pulse and the echoing returned signals are received by a second ultrasonic transducer. As discussed above, an ultrasonic transducer of a device may be used to detect the presence of a user to draw an inference that the user is interacting with the device and manage its operation accordingly. As one non-limiting example, the device may be a computing device such as a laptop computer. When the user is interacting with the laptop, such as by viewing content displayed on the screen and/or listening to audio, it would be desirable to avoid entering a power save mode or otherwise manage operation of the device. However, distinguishing the user from stationary objects that may be within range of the ultrasonic transducer may require detection of relatively small movements, such as breathing or subtle changes in posture. A characteristic of ultrasonic transducers is the presence of noise and variability in the returned signals (i.e., echoes) resulting from sensor design, temperature variations, air flow, and other factors. Correspondingly, conventional techniques for distinguishing a user from a stationary object using an ultrasonic transducer suffer from a high frequency of false positives and false negatives. For example, use of a high pass filter may reject echoes from a stationary target but may also reject echoes from a present user who is still.

Herein, a variety of methods, sonic transducers, devices, and techniques are described for identifying stationary objects as opposed to a user with an ultrasonic transducer. Although this technology is described herein with reference to ultrasonic transducers, it is broadly applicable to any sonic transducer which might be similarly utilized. In the detailed description, the technology is described with examples in which sonic pulses are emitted and received by a single transducer, however the technology may be implemented with a transducer which emits sonic pulses and one or more other transducers which receive returned signals that result from the emissions. Though the sensed environment where detection of stationary objects takes place is often referred to as a room or indoor space in this detailed description, it should be appreciated that the techniques described are applicable to other environments.

Discussion begins with a description of notation and nomenclature. Discussion then shifts to description of some block diagrams of example components of an example devices and a sensor processing unit which may utilize an ultrasonic transducer (or other sonic transducer). The device may be any type of device which utilizes sonic sensing, for example any device which uses ultrasonic transducers may employ the techniques and methods described herein. Discussion then moves to description of a device using a sonic transducer to detect for objects in an environment and within a distance range of interest from the ultrasonic transducer. Returned signals from an emitted pulse are discussed along with methods for utilizing the returned signals to detect a stationary object in an environment of the sonic transducer. Finally, operation of the device, sensor processor, and/or components thereof are described in conjunction with description of a method of detecting a stationary object with an ultrasonic transducer.

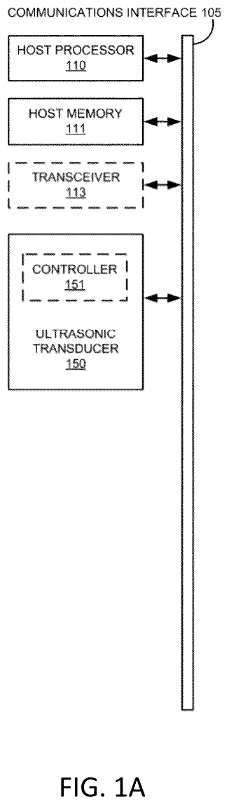

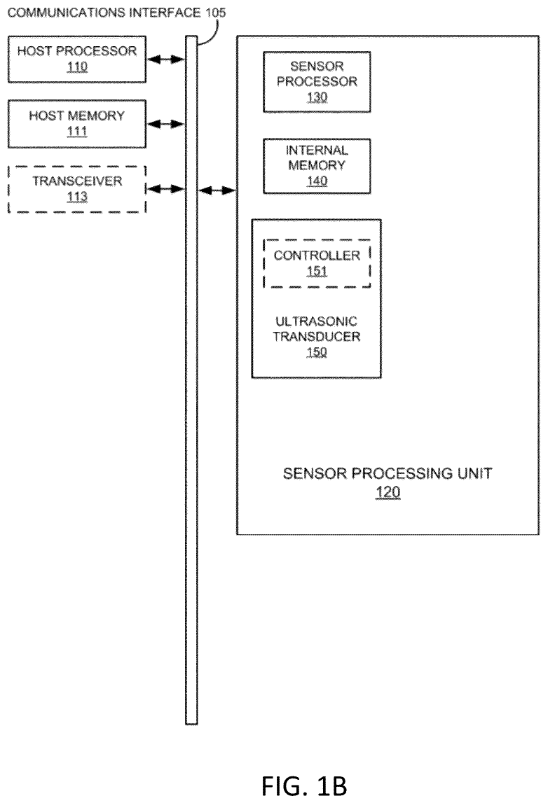

FIGS. 1A and 1B show example block diagrams of some aspects of a device 100 which includes a sonic transducer such as ultrasonic transducer 150, in accordance with various embodiments. Some examples of a device 100 may include, but are not limited to: a desktop or laptop computer, a smart phone, a tablet, a security system, a child monitor, and similar devices. These devices may be generally classified as “moving devices” and “non-moving devices.” A non-moving device is one which is intended to be placed and then remain stationary in that place (e.g., a security sensor). A moving device is one which is self-mobile (e.g., a drone or delivery robot) or which may be moved easily by a human (e.g., a laptop computer). In various embodiments described herein, the techniques for detecting a stationary object may be more readily utilized when the device 100 is stationary even if the device is otherwise self-mobile or easily moved by a human, a determination that may be made using other sensors of the device such as accelerometers or other motion sensors. By way of example, and not of limitation, the device 100 may utilize one or more ultrasonic transducers 150 to detect the presence of objects in the environment of the device 100 or to sense the absence of objects in the environment of device 100 in order to classify detected objects as being a stationary object or a user.

FIG. 1A shows a block diagram of components of an example device 100A, in accordance with various aspects of the present disclosure. As shown, example device 100A comprises a communications interface 105, a host processor 110, host memory 111, and at least one ultrasonic transducer 150. In some embodiments, device 100 may additionally include one a transceiver 113. Though not depicted, some embodiments of device 100A may include one or more additional sensors used to detect motion, position, or environmental context. Some examples of these additional sensors may include, but are not limited to: inertial motion sensors such as gyroscopes and accelerometers, infrared sensors, cameras, microphones, atmospheric pressure sensors, temperature sensors, and global navigation satellite system sensors (i.e., a global positioning system receiver). As depicted in FIG. 1A, included components are communicatively coupled with one another, such as, via communications interface 105.

The host processor 110 may, for example, be configured to perform the various computations and operations involved with the general function of a device 100. Host processor 110 can be one or more microprocessors, central processing units (CPUs), DSPs, general purpose microprocessors, ASICs, ASIPs, FPGAs or other processors which run software programs or applications, which may be stored in host memory 111, associated with the general and conventional functions and capabilities of device 100. In some embodiments, a host processor 110 may perform some amount of the processing of received returned signals from ultrasonic transducer 150 and/or some aspects of the methods of detecting stationary objects that are described herein. Notably, host processor 110 may implement an algorithm configured to determine whether a user is present.

Communications interface 105 may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent and may include a plurality of communications interfaces. Communications interface 105 may facilitate communication between a sensor processing unit (SPU) 120 (see e.g., FIG. 1B) and one or more of host processor 110, host memory 111, transceiver 113, ultrasonic transducer 150, and/or other included components.

Host memory 111 may comprise programs, modules, applications, or other data for use by host processor 110. In some embodiments, host memory 111 may also hold information that that is received from or provided to SPU 120 (see e.g., FIG. 1B). Host memory 111 can be any suitable type of memory, including but not limited to electronic memory (e.g., read only memory (ROM), random access memory (RAM), or other electronic memory). Host memory 111 may include instructions to implement one or more of the methods described herein using host processor 110 and ultrasonic transducer 150.

Transceiver 113, when included, may be one or more of a wired or wireless transceiver which facilitates receipt of data at device 100 from an external transmission source and transmission of data from device 100 to an external recipient. By way of example, and not of limitation, in various embodiments, transceiver 113 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications (or the like) for wireless personal area network communication), and a wired a serial transceiver (e.g., a universal serial bus for wired communication).

Ultrasonic transducer 150 is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as host processor 110. Device 100A may contain a single ultrasonic transducer 150, or may contain a plurality of ultrasonic transducers, for example in the form of an array of ultrasonic transducers. For example, in an embodiment with a single ultrasonic transducer that is used for transmitting (e.g., emitting) and receiving, the ultrasonic transducer may be in an emitting phase for a portion of its duty cycle and in a receiving phase during another portion of its duty cycle.

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals and/or some aspects of the methods of detecting stationary objects that are described herein. For example, controller 151 may implement the user presence algorithm alone or in conjunction with host processor 110.

FIG. 1B shows a block diagram of components of an example device 100B, in accordance with various aspects of the present disclosure. Device 100B is similar to device 100A except that it includes a sensor processing unit (SPU) 120 in which ultrasonic transducer 150 is disposed. SPU 120, when included, comprises: a sensor processor 130; an internal memory 140; and at least one ultrasonic transducer 150. Though not depicted, in some embodiments, SPU 120 may additionally include one or more motion sensors and/or one or more other sensors such a light sensor, infrared sensor, GNSS sensor, temperature sensor, barometric pressure sensor, microphone, an audio recorder, a camera, etc. In some embodiments SPU 120 may trigger the operation of one or more of these other sensors in response to detecting the presence of a stationary object with an ultrasonic transducer 150 (e.g., an audio recorder and/or camera may be triggered to activate). In various embodiments, SPU 120 or a portion thereof, such as sensor processor 130, is communicatively coupled with host processor 110, host memory 111, and/or other components of device 100 through communications interface 105 or other well-known means. SPU 120 may also comprise one or more communications interfaces (not shown) similar to communications interface 105 and used for communications among one or more components within SPU 120.

Sensor processor 130 can be one or more microprocessors, CPUs, DSPs, general purpose microprocessors, ASICs, ASIPs, FPGAs or other processors that run software programs, which may be stored in memory such as internal memory 140 (or elsewhere), associated with the functions of SPU 120. In some embodiments, one or more of the functions described as being performed by sensor processor 130 may be shared with or performed in whole or in part by another processor of a device 100, such as host processor 110. In some embodiments, a sensor processor 130 may perform some amount of the processing of received returned signals and/or some aspects of the methods of detecting stationary objects that are described herein, including implementing a user presence detection algorithm for example.

Internal memory 140 can be any suitable type of memory, including but not limited to electronic memory (e.g., read only memory (ROM), random access memory (RAM), or other electronic memory). Internal memory 140 may store algorithms, routines, or other instructions for instructing sensor processor 130 on the processing of data output by one or more of ultrasonic transducer 150 and/or other sensors. In some embodiments, internal memory 140 may store one or more modules which may be algorithms that execute on sensor processor 130 to perform a specific function. Some examples of modules may include, but are not limited to: statistical processing modules, motion processing modules, object detection modules, object location modules, and/or decision-making modules. Modules may include instructions to implement one or more of the methods described herein using host processor 110, sensor processor 130, and or controller 151.

Ultrasonic transducer 150, as previously described, is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as sensor processor 130 and/or host processor 110. Ultrasonic transducer 150 is communicatively coupled with sensor processor 130 by a communications interface (such as communications interface 105), bus, or other well-known communication means.

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals, may perform some aspects of the methods of detecting stationary objects that are described herein, and/or may interpret and carryout instructions received from external to ultrasonic transducer 150. As noted above, controller 151 may implement the user presence algorithm alone or in conjunction with host processor 110 and/or sensor processor 130.

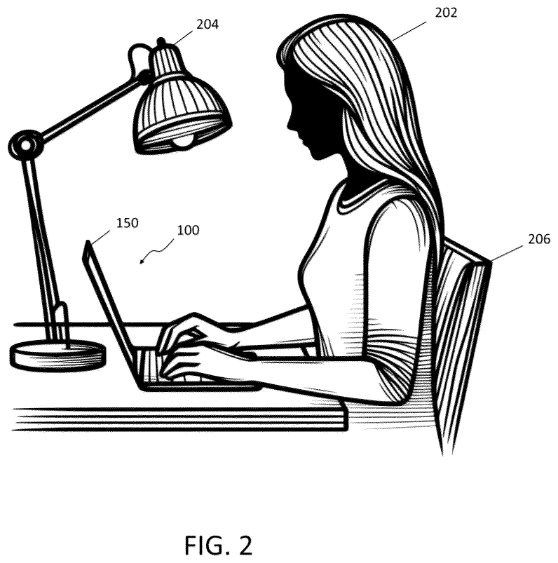

Turning now to FIG. 2, an exemplary use case is depicted of device 100, implemented here as a laptop computer, using a sonic transducer such as ultrasonic transducer 150 to detect objects, in accordance with various embodiments. Typical objects that may be detected include user 202 and stationary objects such as desk lamp 204 and chair back 206. As discussed above, it would be desirable to distinguish the stationary objects from user 202 who may be relatively still.

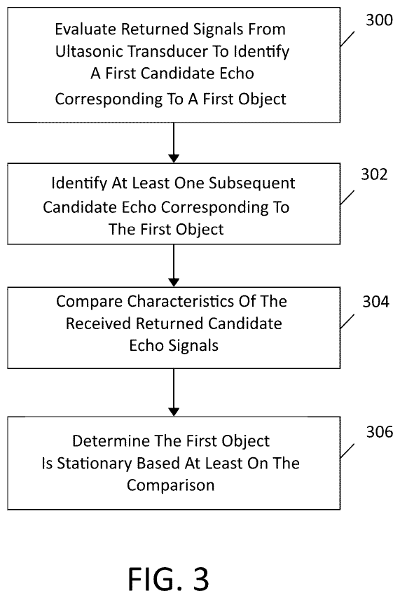

To help illustrate aspects of the disclosed techniques, FIG. 3 illustrates a flow diagram of a method of detecting a stationary object with an ultrasonic transducer, in accordance with various embodiments. As noted above, an ultrasonic transducer is used to emit an ultrasonic pulse and receive returned signals corresponding to the emitted ultrasonic pulse. Correspondingly, beginning with 300, the method may involve evaluating the returned signals to identify a first candidate echo indicating a first object within range of the ultrasonic transducer. In 302, at least one subsequent candidate echo resulting from a subsequent emitted ultrasonic pulse and a subsequent received returned signal that corresponds to the first object may be identified. In 304, characteristics of the received returned signal and the subsequent received returned signal are compared. Based at least in part on that comparison, the first candidate echo may be determined to represent a stationary object in 306. The comparison of candidate echoes may involve characteristics including amplitude, range and/or width. When the characteristics of the candidate echo remains constant for a sufficient period of time, the stationary object determination may be made. As one example, the period of time may be at least two seconds. Further, for the purposes of this disclosure, the criteria for determining when a characteristic of the candidate echo may be considered constant may be selected and/or adjusted to achieve the desired performance. To help illustrate and without limitation, the range associated with a candidate echo may be considered constant when it is within 1 sample, corresponding to 2 cm. For other characteristics of the candidate echo, such as amplitude and/or width, it may be desirable to use different criteria depending on the range, with higher tolerance for closer objects. One example is to consider the characteristic constant when within approximately 25% for objects closer than 30 cm and when within approximately 12% for objects farther away.

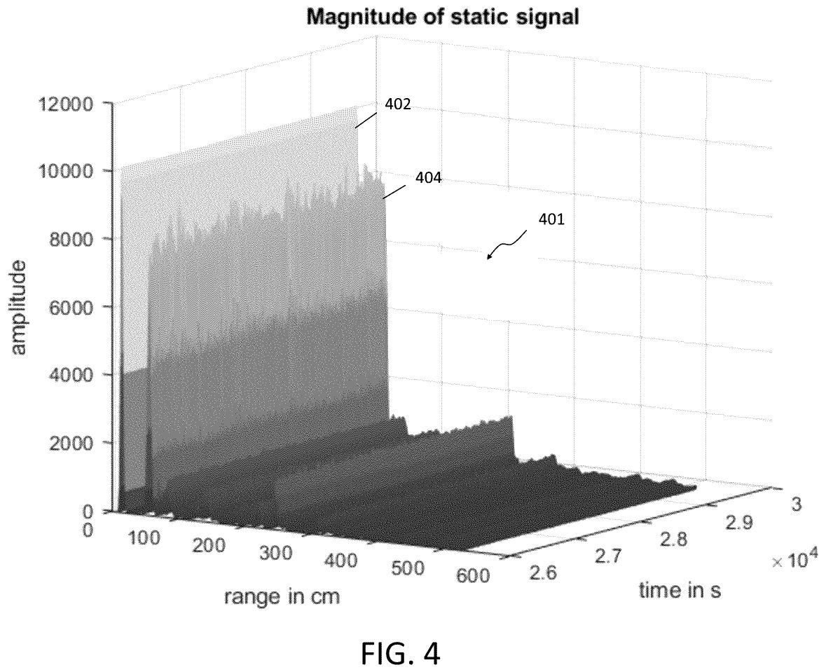

Referring now to FIG. 4, a graph illustrates raw magnitudes of returned signals 401 received over a period of time by an ultrasonic transducer 150 in a sensed environment such as a room (e.g., an indoor space such as the sensed environment of FIG. 2), in accordance with various embodiments. In this example, user 202 is not present and the received candidate echoes may be evaluated for determination of whether they represent stationary objects. As can be seen, a first peak 402 in signal exhibits very high amplitude and corresponds to a phenomena resulting from operation of the transducer. Specifically, ultrasonic transducer 150 vibrates while emitting a pulse (in the emitting portion of its duty cycle) and perhaps shortly afterward due to the emission of the pulse. This vibration due to the emission of a pulse from a transducer has is referred to as “ringdown.” Following this, a succession of peaks corresponding to candidate echoes are received, including peak 404 at a range of approximately 55 cm which results from reflections off chair back 206.

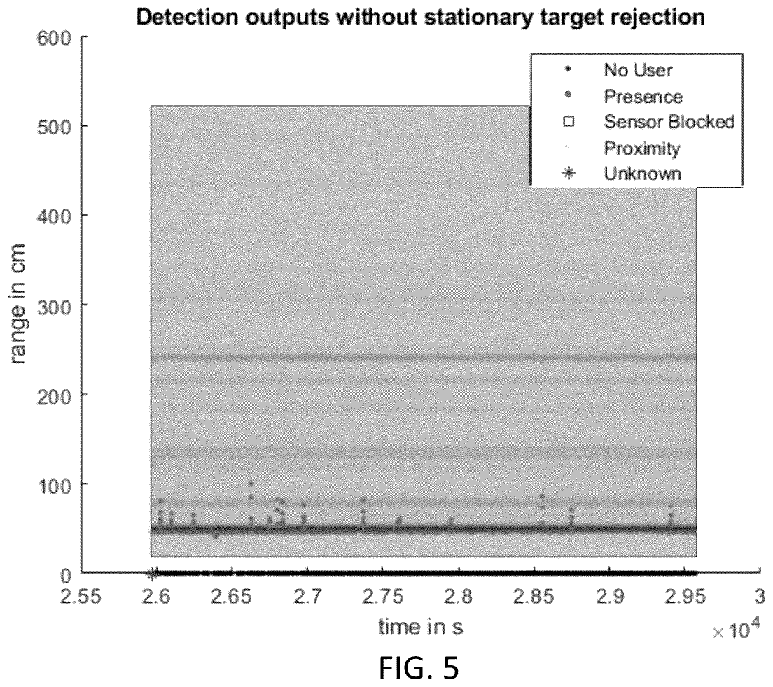

Next, FIG. 5 schematically illustrates the output of a conventional presence detection algorithm. Although a “no user” determination as indicated by the black dots at a range of 0 cm is correctly made most of the time, there are nevertheless multiple, ongoing false detections output as indicated by the light dots at ranges from approximately 50 to 100 cm. As discussed above, it has been found that a mesh chair back may return signals with relatively high noise which can exacerbate the false detections.

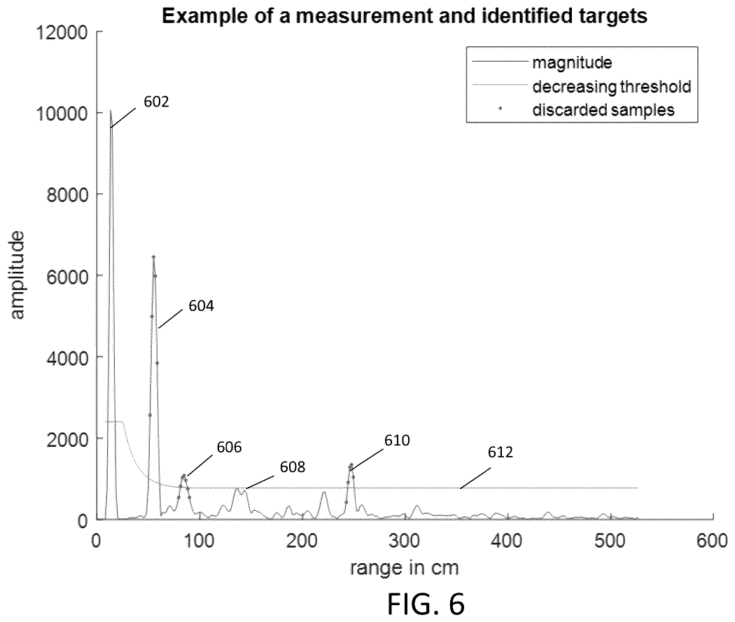

Conversely, FIG. 6 schematically plots amplitude against range, shown for a single ultrasonic pulse in the interest of clarity. The first peak 602 represents ringdown and the subsequent peaks 604, 606, 608 and 610 are candidate echoes to which the stationary object determination techniques of this disclosure may be applied. As discussed above, characteristics such as amplitude, range and width are compared over a period of time (again, only the signals from one emitted pulse is shown in this view). When the values are sufficiently constant, a determination can be made that the object represented by the candidate echo is stationary. In this illustration, peaks 604, 606 and 610 have stable characteristics over time and are determined to represent stationary objects at approximately 55 cm, 85 cm and 250 cm, respectively. However, peak 608 is not sufficiently constant over time and is not determined to represent a stationary object. Further, in some embodiments a decreasing amplitude threshold as indicated by curve 612 may be employed. Here, peaks 604, 606 and 610 each exceed the threshold and qualify as being potential stationary objects, subject to the characteristics noted above exhibiting sufficient constancy over time. In contrast, peak 608 does not exceed the threshold and therefore is not classified as representing a stationary object. Based on these determinations, samples corresponding to the peaks that represent stationary objects may be excluded from the user presence detection algorithm. The excluded samples are indicated as dots on peaks 604, 606 and 610, while no samples are excluded from peak 608 given that there is insufficient confidence it represents a stationary object.

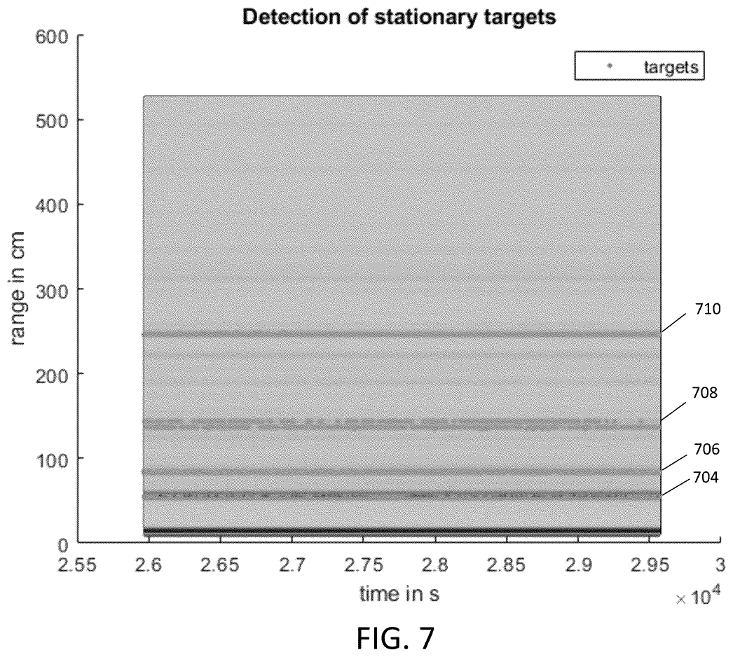

The samples over time from FIG. 6 are schematically depicted in FIG. 7, with bands 704, 706, 708 and 710 corresponding to the respective peaks 604, 606, 608 and 610 (ringdown is not shown here for clarity). As can be seen, bands 704, 706 and 710 exhibit a constant range over time. Given that the other requisite characteristics (such as amplitude and width, not shown here) are sufficiently constant, the objects represented by these samples may be considered stationary. Conversely, band 708 varies in range and therefore is not determined to represent a stationary object. As discussed above, this candidate echo was also not considered to represent a stationary object because the amplitudes of the samples did not exceed threshold 612.

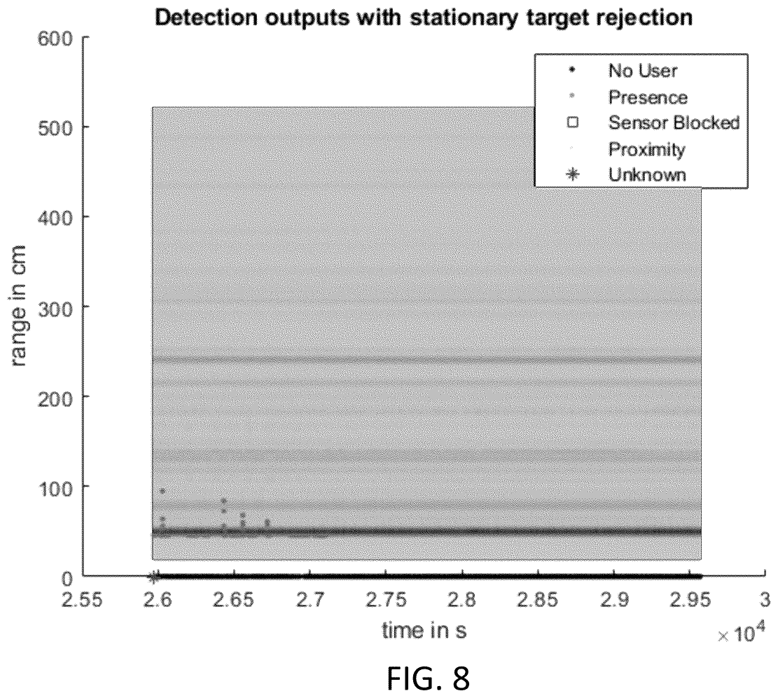

For comparison, FIG. 8 schematically illustrates the output of a presence detection algorithm when samples corresponding to objects that have been determined to be stationary are excluded, as a comparison to the conventional technique of FIG. 5. Again, a “no user” determination as indicated by the black dots at a range of 0 cm. The false detections indicated by the dots ranging from approximately 50 to 100 cm quickly taper to zero once a sufficient period of time has elapsed to determine characteristics of the candidate echoes are sufficiently constant so that they may be classified as representing stationary objects.

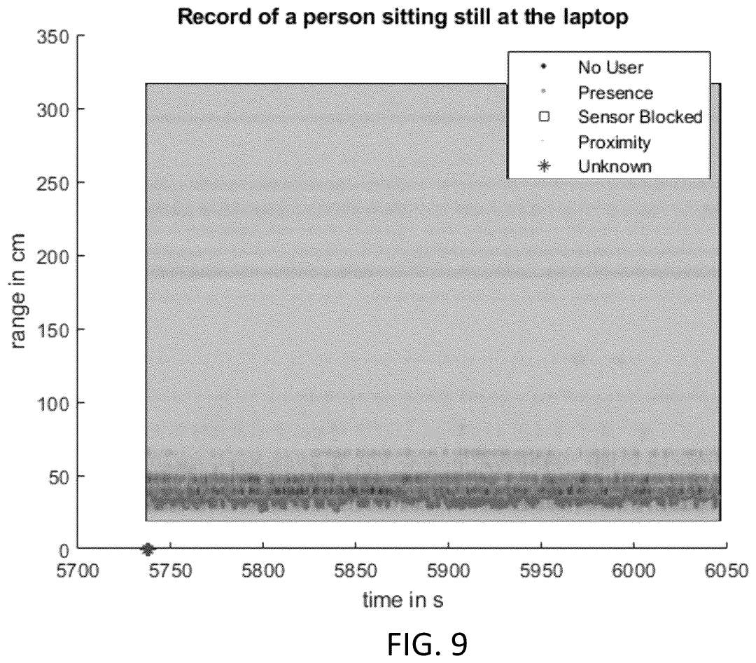

Finally, FIG. 9 schematically illustrates the output of a presence detection algorithm when a user is present. As shown, there are multiple detections indicated by the dots in the range of approximately 30 to 40 cm. However, because the characteristics of the candidate echoes corresponding to the user do not meet the criteria discussed above, these samples are not excluded from the presence detection algorithm and a “no user” determination is not output as indicated by the absence of black dots at the 0 cm range.

Another benefit of the techniques of this disclosure is the ability correctly interpret stationary objects that may be intermittently shadowed. For example, when a user occupies different positions, more distant objects may be blocked so that an emitted pulse is not reflected. If the user moves to a different position that does not block a given object, its sudden reappearance may be incorrectly classified as a non-stationary object. However, since the techniques of this disclosure involve tracking such objects over time, the reappearance of a candidate echo having sufficiently constant characteristics can be correlated with a previous identification to allow for appropriate classification.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. In some configurations, a substrate portion known as a MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a sensor tracking module also referred to as Sensor Processing Unit (SPU) that includes at least one sensor in addition to electronic circuits. The sensor, such as a gyroscope, a magnetometer, an accelerometer, a microphone, a pressure sensor, a proximity sensor, or an ambient light sensor, among others known in the art, are contemplated. Some embodiments include accelerometer and gyroscope, which each provide a measurement along three axes that are orthogonal to each other. Such a device is often referred to as a 6-axis device. Other embodiments include accelerometer, gyroscope, and magnetometer, which each provide a measurement along three axes that are orthogonal to each other. Such a device is often referred to as a 9-axis device. Other embodiments may not include all the sensors or may provide measurements along one or more axes. The sensors may be formed on a first substrate. Other embodiments may include solid-state sensors or any other type of sensors. The electronic circuits in the SPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data may refer to processed and/or raw data. Processing may include applying a sensor fusion algorithm or applying any other algorithm. In the case of a sensor fusion algorithm, data from a plurality of sensors may be combined to provide, for example, an orientation of the device. In the described embodiments, a SPU may include processors, memory, control logic and sensors among structures.

As discussed above, this disclosure is directed to a device having an ultrasonic transducer configured to emit an ultrasonic pulse and receive returned signals corresponding to the emitted ultrasonic pulse. The device also has at least one processor coupled with the ultrasonic transducer and configured to evaluate the returned signals to identify a first candidate echo indicating a first object within range of the ultrasonic transducer, identify at least one subsequent candidate echo resulting from a subsequent emitted ultrasonic pulse and a subsequent received returned signal that corresponds to the first object, compare characteristics of the received returned signal and the subsequent received returned signal and determine the first candidate echo represents a stationary object.

In one aspect, the at least one processor may be further configured to characterize the first object as not being a user of the device.

In one aspect, the characteristics of the received return signals comprise at least one of amplitude, width and range. Further, the characteristics of the received return signals may be each of amplitude, width and range.

In one aspect, the at least one subsequent candidate echo may be a plurality of candidate echoes. The plurality of candidate echoes may be received over a period of at least 2 seconds.

In one aspect, the at least one processor may be configured to compare at least one characteristic of the received returned signals using a decreasing threshold for at least one of the characteristics of the received returned signals when characterizing the first candidate echo as representing a stationary object. The at least one characteristic of the received return signals may be amplitude.

In one aspect, characterizing the first candidate echo as representing a stationary object may occur when movement of a user unblocks candidate echoes.

In one aspect, characterization of the first candidate echo as representing a stationary object is conveyed to a user presence detection module of the device.

In one aspect, the at least one processor may be further configured to determine multiple objects are stationary based on a comparison of characteristics of the received returned signals.

This disclosure may include a sensor processing unit, including an ultrasonic transducer configured to emit an ultrasonic pulse and receive returned signals corresponding to the emitted ultrasonic pulse and at least one sensor processor coupled with the ultrasonic transducer and configured to evaluate the returned signals to identify a first candidate echo indicating a first object within range of the ultrasonic transducer, identify at least one subsequent candidate echo resulting from a subsequent emitted ultrasonic pulse and a subsequent received returned signal that corresponds to the first object, compare characteristics of the received returned signal and the subsequent received returned signal and determine the first candidate echo represents a stationary object.

In one aspect, the characteristics of the received return signals may be at least one of amplitude, width and range.

In one aspect, the at least one processor may be configured to compare at least one characteristic of the received returned signals using a decreasing threshold for at least one of the characteristics of the received returned signals when characterizing the first candidate echo as representing a stationary object.

In one aspect, determining the first candidate echo represents a stationary object occurs when movement of a user unblocks candidate echoes.

In one aspect, the at least one processor is may be configured to determine multiple objects are stationary based on a comparison of characteristics of the received returned signals.

Further, this disclosure is also directed to a method for employing an ultrasonic sensor to identify a stationary object. The method may involve evaluating, employing at least one processor coupled with an ultrasonic transducer, returned signals from a pulse emitted by the ultrasonic transducer, identifying at least one subsequent candidate echo resulting from a subsequent emitted ultrasonic pulse and a subsequent received returned signal that corresponds to the first object, comparing characteristics of the received returned signal and the subsequent received returned signal and determining the first candidate echo represents a stationary object.

In one aspect, the characteristics of the received return signals comprise at least one of amplitude, width and range.

In one aspect, determining the first candidate echo represents a stationary object occurs when movement of a user unblocks candidate echoes.

In one aspect, the method may involve determining multiple objects are stationary based on a comparison of characteristics of the received returned signals.

Although the present invention has been described in accordance with the embodiments shown, one of ordinary skill in the art will readily recognize that there may be variations to the embodiments and those variations would be within the spirit and scope of the present invention. One skilled in the art may readily devise other systems consistent with the disclosed embodiments which are intended to be within the scope of this disclosure.

What is claimed is:

1. A device comprising:
an ultrasonic transducer configured to emit an ultrasonic pulse and receive returned signals corresponding to the emitted ultrasonic pulse; and
at least one processor coupled with the ultrasonic transducer and configured to:
evaluate the returned signals to identify a first candidate echo indicating a first object within range of the ultrasonic transducer;
identify at least one subsequent candidate echo resulting from a subsequent emitted ultrasonic pulse and a subsequent received returned signal that corresponds to the first object;
compare characteristics of the received returned signal and the subsequent received returned signal; and
determine the first candidate echo represents a stationary object.

2. The device of claim 1, wherein the at least one processor is further configured to characterize the first object as not being a user of the device.

3. The device of claim 2, wherein the characteristics of the received return signals comprise at least one of amplitude, width and range.

4. The device of claim 3, wherein the characteristics of the received return signals comprise each of amplitude, width and range.

5. The device of claim 1, wherein the at least one subsequent candidate echo comprises a plurality of candidate echoes.

6. The device of claim 5, wherein the plurality of candidate echoes are received over a period of at least 2 seconds.

7. The device of claim 1, wherein the at least one processor is configured to compare at least one characteristic of the received returned signals using a decreasing threshold for at least one of the characteristics of the received returned signals when determining the first candidate echo represents a stationary object.

8. The device of claim 7, wherein the at least one characteristic of the received return signals is amplitude.

9. The device of claim 1, wherein determining the first candidate echo represents a stationary object occurs when movement of a user unblocks candidate echoes.

10. The device of claim 1, wherein the characterization of the first candidate echo as representing a stationary object is conveyed to a user detection module of the device.

11. The device of claim 1, wherein the at least one processor is further configured to determine multiple objects are stationary based on a comparison of characteristics of the received returned signals.

12. A sensor processing unit comprising:
an ultrasonic transducer configured to emit an ultrasonic pulse and receive returned signals corresponding to the emitted ultrasonic pulse; and
at least one sensor processor coupled with the ultrasonic transducer and configured to:
evaluate the returned signals to identify a first candidate echo indicating a first object within range of the ultrasonic transducer;
identify at least one subsequent candidate echo resulting from a subsequent emitted ultrasonic pulse and a subsequent received returned signal that corresponds to the first object;
compare characteristics of the received returned signal and the subsequent received returned signal; and
determine the first candidate echo represents a stationary object.

13. The sensor processing unit of claim 12, wherein the characteristics of the received return signals comprise at least one of amplitude, width and range.

14. The sensor processing unit of claim 12, wherein the at least one processor is configured to compare at least one characteristic of the received returned signals using a decreasing threshold for at least one of the characteristics of the received returned signals when characterizing the first candidate echo as representing a stationary object.

15. The sensor processing unit of claim 12, wherein determining the first candidate echo represents a stationary object occurs when movement of a user unblocks candidate echoes.

16. The sensor processing unit of claim 12, wherein the at least one processor is further configured to determine multiple objects are stationary based on a comparison of characteristics of the received returned signals.

17. A method for employing an ultrasonic sensor to identify a stationary object, comprising:
evaluating, employing at least one processor coupled with an ultrasonic transducer, returned signals from a pulse emitted by the ultrasonic transducer;
identifying at least one subsequent candidate echo resulting from a subsequent emitted ultrasonic pulse and a subsequent received returned signal that corresponds to the first object;
comparing characteristics of the received returned signal and the subsequent received returned signal; and
determining the first candidate echo represents a stationary object.

18. The method of claim 17, wherein the characteristics of the received return signals comprise at least one of amplitude, width and range.

19. The method of claim 17, wherein determining the first candidate echo represents a stationary object occurs when movement of a user unblocks candidate echoes.

20. The method of claim 17, further comprising determining multiple objects are stationary based on a comparison of characteristics of the received returned signals.
